(19) United States
(12) Patent Application Publication
(10) Pub. No.: US 2026/0204530 A1
(43) Pub. Date: Jul. 16, 2026

(54) Analytical instrument with switchable detection circuitry

(71) Applicant: Thermo Fisher Scientific (Bremen) GmbH, Bremen (DE)

(72) Inventors: Frank Czemper, Bremen (DE); Ralf Günter Hartmer, Hamburg (DE); Frederik Busse-Patel, Bremen (DE)

(21) Appl. No.: 19/437,152

(22) Filed: Dec. 30, 2025

(30) Foreign Application Priority Data
Jan. 13, 2025 (GB) 2500389.8

(51) Int. Cl. H01J 49/02; H01J 49/42

(52) U.S. Cl. CPC H01J 49/022; H01J 49/027; H01J 49/4265

(57) ABSTRACT

An analytical instrument comprises an ion detector configured to detect ions and to produce an ion signal characteristic of the detected ions, and detection circuitry comprising an input configured to receive an ion signal from the ion detector, a high-pass filter configured to filter a received ion signal, and an output. The ion detector is configured to detect ions in a first mode of operation and to detect ions in a second mode of operation. The detection circuitry is configured such that: (i) ion signals produced by the ion detector in the first mode of operation are provided to the output without being filtered by the high-pass filter; and such that (ii) ion signals produced by the ion detector in the second mode of operation are filtered by the high-pass filter before being provided to the output.

### FIELD

The present disclosure relates to the field of mass spectrometry, and in particular to mass spectrometry employing image current detection of ions, such as Fourier Transform (FT) mass spectrometry using electrostatic traps.

### BACKGROUND

Fourier transform mass spectrometers typically employ ion traps. For example, Orbitrap™ instruments from Thermo Fisher Scientific accumulate ions in a curved linear ion trap (“C-Trap”) before injecting the accumulated ions into an electrostatic orbital trap for high-resolution accurate mass analysis by image current detection.

Numerous methods of automatic gain control (AGC) have been proposed to control the total number of ions accumulated in an ion trap despite a variable flux of ions into the trap. These methods typically make use of measurements or estimations of an earlier ion current to estimate the present ion current. The accumulation time (e.g. fill time) of ions into the trap is then adjusted based on the present ion current estimation to control the total number of ions accumulated in the ion trap.

UK Patent No. 2618673 describes a method in which an electrostatic orbital trap mass analyser is used both in its normal image current detection (mass analysis) mode of operation, and in an ion current measurement mode of operation by allowing ions to directly impact upon the image current detection electrodes. This provides an efficient and low-cost mechanism for ion current measurements (as no additional hardware is required) and improves the comparability between ion current and image current measurements, as both are taken at the same location and thus suffer from the same ion losses during the ions’ transit through the instrument.

It is believed that there remains scope for improvements to apparatus and methods for mass analysis.

### SUMMARY

A first aspect provides an analytical instrument comprising:

an ion detector configured to detect ions and to produce an ion signal characteristic of the detected ions; and

detection circuitry comprising a first input configured to receive an ion signal from the ion detector, a filter configured to filter a received ion signal, and a first output;

wherein the ion detector is configured to detect ions in a first mode of operation and to detect ions in a second mode of operation; and

wherein the detection circuitry is configured such that: (i) an ion signal produced by the ion detector in the first mode of operation is provided to the first output without being filtered by the filter; and such that (ii) an ion signal produced by the ion detector in the second mode of operation is filtered by the filter before being provided to the first output.

Embodiments provide an analytical instrument (such as a mass spectrometer) comprising an ion detector (such as a mass analyser) that is configured to detect ions in at least two different modes of operation. The ion detector may be configured to measure a current or charge of ions in the first mode of operation (e.g. by causing ions to impact upon one or more detection electrode(s) of the detector) and may be configured to mass analyse ions by image current detection in the second mode of operation (e.g. by detecting image current signals from ions trapped within the detector). The instrument also comprises detection circuitry configured to receive and process signals produced by the detector in the first and second modes of operation.

It has been recognised that it is beneficial to subject the signals produced by the detector in the different modes of operation to different types of processing. In particular, and as is described in more detail below, it is beneficial to (high-pass) filter signals produced in the mass analysis mode of operation, while such filtering would be detrimental to signals produced in the current measurement mode of operation. In embodiments, the detection circuitry comprises a filter and is configured such that ion signals produced by the ion detector in the first mode of operation are provided to an output without being filtered by the filter; and such that ion signals produced by the ion detector in the second mode of operation are filtered by the filter before being provided to the output. This represents a particularly convenient and efficient arrangement for processing ion signals produced by the mass analyser in its two different modes of operation using substantially the same detection circuitry.

It will be appreciated, therefore, that embodiments provide improved apparatus and methods for mass analysis.

The filter may be a high-pass filter configured to filter a received ion signal to produce a high-pass filtered version of the received ion signal. As is described in more detail below, high-pass filtering signals obtained in the second (mass analysis) mode of operation has the effect of significantly improving their processing by removing unwanted noise.

The detection circuitry may comprise a first switch configured to receive an ion signal from the first input, a second switch configured to provide an ion signal to the first output, a first signal path between the first and second switches, and a second (independent) signal path between the first and second switches. The first signal path may include the filter and the second signal path may bypass (i.e. may be an independent signal path from) the filter.

The detection circuitry may be configured such that: (i) an ion signal produced by the ion detector in the first mode of operation is provided to the first output via the first signal path; and such that (ii) an ion signal produced by the ion detector in the second mode of operation is provided to the first output via the second signal path. To do this, the first switch may have a single input connected to the first input, and a pair of outputs respectively connected to the first and second signal paths; and the second switch may have a pair of inputs respectively connected to the first and second signal paths, and a single output connected to the first output. The first and second switches may be controlled such that ion signals produced by the detector operating in the first mode take the first signal path (and are filtered by the filter) while ion signals produced by the detector operating in the second mode take the second signal path (and are not filtered by the filter).

The first input may comprise a first operation amplifier and/or the first output may comprise a second operational amplifier. The detection circuitry may comprise a differential amplifier configured to receive an input ion signal from the image current detection electrodes and to provide an output ion signal to the first input.

Thus, embodiments provide a pre-amplifier having a signal path which is switchable between a first path which includes the filter (and which is used for signals produced by the detector operating in the second (mass analysis) mode of operation) and a second signal path which does not include the filter (and which is used for signals produced by the detector operating in the first (ion current measuring) mode of operation). This represents a particularly convenient and efficient arrangement which improves the processing of signals produced by the ion detector in its two different modes of operation.

Each of the first and/or second switch may be formed from one or more passive electronic component(s) such as a MEMS switch, and without any active electrical components (like transistors, etc.). Similarly, the filter may be formed from one or more passive electronic component(s), and without any active electrical components. Beneficially, the use of only passive electronic components means that these components will not add any additional RF noise to the signals, which could otherwise result in additional unwanted signals in the mass spectrum.

The instrument may be configured such that an ion signal produced by the ion detector in the first mode of operation is characteristic of a first property of the ions and an ion signal produced by the ion detector in the second mode of operation is characteristic of a second different property of the ions. The first property may be a current or charge of the ions and/or the second property may be a mass to charge ratio (m/z) of the ions.

The detection circuitry may comprise processing circuitry configured to process an ion signal provided to the first output, wherein the processing circuitry is configured to determine a first property of ions detected in the first mode of operation and to determine a second different property of ions detected in the second mode of operation. The processing circuitry may comprise a digitiser configured to digitise an ion signal received from the first output, and one or more digital signal processor(s) configured to process the digitised ion signal. The first property may be a current or charge of the ions and/or the second property may be a mass to charge ratio (m/z) of the ions.

The ion detector may comprise an ion trap that comprises one or more detection electrodes configured to detect image current signals from ions accumulated within the ion trap. The ion trap may be an ion trap mass analyser such as an electrostatic orbital trap mass analyser. The instrument may be operated in the second (mass analysis) mode of operation, wherein ions passed to the ion trap are caused to remain within the trap without impacting upon the detection electrode(s). The ion trap may be configured such that its detection electrode(s) can be used to detect image current signals from a batch of ions held within the ion trap. Fourier transformation of an image current signal detected by the detection electrode(s) may be used to produce a mass spectrum of a batch of ions within the trap.

In addition to this second (mass analysis) mode of operation, the detection electrode(s) of the ion trap may be used in the first mode of operation to determine an ion current of or a (total amount of) charge of a group of ions by deliberately causing that group of ions to impact upon one or more of the detection electrode(s).

Thus, the instrument may be configured such that in the first mode of operation, ions passed to the ion trap are caused to impact upon one or more of the detection electrode(s) of the ion trap so as to produce an ion signal. The instrument may be configured such that in the second mode of operation, ions passed to the ion trap are trapped within the ion trap, and the one or more detection electrodes are used to detect image current signals from the ions trapped within the ion trap. The instrument may be configured such that, in the first mode of operation, ions are caused to impact upon one or more of the one or more detection electrode(s) that are configured to detect image current signals from ions trapped within the ion trap and/or upon one or more of the one or more detection electrode(s) that are electrical connected to one or more of the detection electrode(s) that are configured to detect image current signals from ions trapped within the ion trap.

The ion current or charge measurements can be used in automatic gain control (AGC) procedures. Thus, the determined ion current or charge of a group of ions can be used to control the number of ions in a batch of ions subsequently accumulated in the ion trap. By using the detection electrode(s) of the ion trap itself to provide an ion current or charge measurement for the AGC procedure, there is no need to provide additional hardware elsewhere in the instrument for this purpose. This can then beneficially reduce the complexity, size and cost of the instrument, as well as increase its reliability and robustness.

Furthermore, using the detection electrode(s) of the ion trap itself for ion current or charge measurements can improve the accuracy of the AGC procedure, i.e. can result in more accurate control of the number of ions in a batch of ions accumulated in the ion trap. This is because the measurements will more accurately take account of inevitable ion losses during the process of passing ions to the ion trap; whereas measurements made using an electrometer positioned elsewhere in the instrument outside of the ion trap will not take account of these losses and will instead take account of the different ion losses that occur during the process of passing ions to the electrometer.

Thus, in embodiments, the instrument comprises a control system configured to use the determined ion current or charge of a group of ions to control the number of ions in a batch of ions subsequently trapped in the ion trap. The ion trap may be a primary ion trap, and the instrument may be configured to accumulate a group of ions within a secondary ion trap arranged upstream of the primary ion trap and to pass the accumulated group of ions from the secondary ion trap to the primary ion trap. The secondary ion trap may be a linear ion trap such as a curved linear ion trap.

Another aspect provides a method of operating an analytical instrument that comprises an ion detector and detection circuitry comprising a filter, the method comprising:

the ion detector detecting ions in a first mode of operation and producing a first ion signal characteristic of the detected ions, the detection circuitry receiving the ion signal from the ion detector, and the detection circuitry passing the received ion signal to an output without the ion signal being filtered by the filter; and

the ion detector detecting ions in a second mode of operation and producing a second ion signal characteristic of the detected ions, the detection circuitry receiving the ion signal from the ion detector, the filter filtering the ion signal, and the detection circuitry providing the filtered version of the signal to the output.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

These aspects can, and in embodiments do, include any one or more or each of the optional features described herein.

### DESCRIPTION OF THE DRAWINGS

Various embodiments will now be described in more detail with reference to the accompanying Figures, in which:

FIG. 1 shows schematically a mass spectrometer in accordance with embodiments;

FIG. 2 shows schematically detail of a mass analyser in accordance with embodiments;

FIG. 3 shows schematically a mass spectrometer in accordance with embodiments;

FIG. 4 shows schematically a mass analyser in accordance with embodiments;

FIG. 5 shows schematically a method of operating a mass spectrometer in accordance with embodiments;

FIG. 6 shows schematically a preamplifier in accordance with embodiments;

FIG. 7 shows schematically detail of a preamplifier in accordance with embodiments; and

FIG. 8 shows transient signals obtained using a mass analyser operating in different modes of operation.

### DETAILED DESCRIPTION

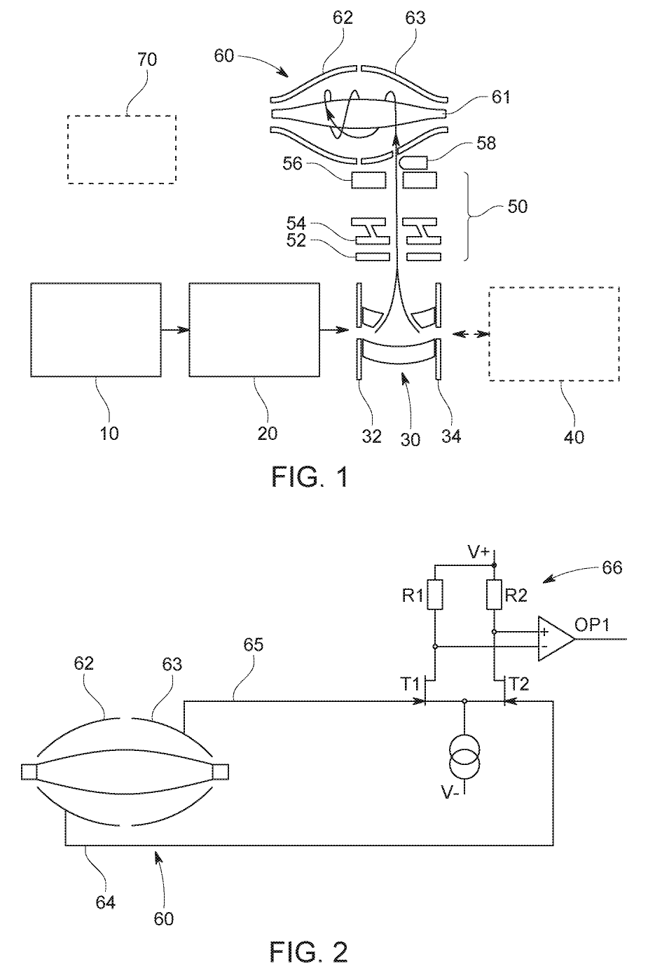

FIG. 1 illustrates schematically an analytical instrument, such as a mass spectrometer, that may be operated in accordance with embodiments. As shown in FIG. 1, the instrument includes an ion source 10, one or more ion transfer stages 20, a mass analyser 60 in the form of a primary ion trap, and a secondary ion trap 30.

The ion source 10 is configured to generate ions from a sample. The ion source 10 may be coupled to a separation device (not shown) such as a liquid chromatography (LC) separation device, a gas chromatography (GC) separation device, or a capillary electrophoresis separation device, and the like, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar. Numerous other types of ionisation are possible. More than one ion source may be provided and used. The ions may be any suitable type of ions to be analysed, e.g. small and large organic molecules, biomolecules, DNA, RNA, proteins, peptides, fragments thereof and the like.

The ion transfer stage(s) 20 are arranged downstream of the ion source 10 and may include an atmospheric pressure interface and one or more ion guides, lenses and/or other ion optical devices configured such that some or all of the ions generated by the ion source 10 can be transferred from the ion source 10 to the secondary ion trap 30. The ion transfer stage(s) 20 may include any suitable number and configuration of ion optical devices, for example optionally including one or more RF and/or multipole ion guides, one or more ion guides for cooling ions, one or more mass selective ion guides (e.g. a mass filter such as a quadrupole mass filter), and so on.

The secondary ion trap 30 is arranged downstream of the ion transfer stage(s) 20 and is configured to receive and accumulate ions from the ion source 10 (via the one or more ion transfer stages 20). The secondary ion trap 30 can comprise any suitable ion trap, such as a quadrupole ion trap. The ion trap 30 may be elongated in an axial direction (thereby defining a trap axis) in which the ions enter the trap. Ions may be trapped radially in the trap 30 by applying RF voltage(s) to trapping (e.g. rod) electrodes of the trap. As shown in FIG. 1, the secondary ion trap 30 may be a curved linear ion trap (C-trap), i.e. where the trapping rod electrodes are curved. However, the ion trap 30 may be any other suitable type of ion trap, such as for example a linear ion trap.

The ion trap 30 includes an entrance lens or gate 32 and an exit lens or gate 34. Ions from the ion source 10 can be accumulated in the ion trap 30 by operating the exit lens 34 in its closed mode, while operating the entrance lens 32 in its open mode. After a desired ion fill time of ions into the ion trap 30, the entrance lens 32 can be closed (by altering the voltage applied to the entrance lens 32) such that ions cannot pass out of the trap 30 and such that ions from the ion source 10 can no longer enter the ion trap 30. In some embodiments, more accurate gating of the incoming ion beam into the trap 30 can be provided by a lens or gate electrode within the ion transfer stage(s) 20 upstream of the secondary ion trap. In these embodiments, the lens or gate electrodes may be configured such that the transmission of ions into the ion trap 30 can be switched on or off.

Thus, the instrument is configured such that ions can be accumulated in the secondary ion trap 30 with an adjustable accumulation time (fill time). By controlling the fill time of ions into the trap, where the flux of ions into the trap 30 is known or can be approximated, the total number of ions accumulated in the ion trap 30 can be controlled.

As illustrated by FIG. 1, once accumulated in the secondary ion trap 30, ions within the trap can be ejected into the primary ion trap 60. The ions may be ejected from the secondary trap 30 in a direction orthogonal to the axis of the trap (orthogonal ejection), for example by applying one or more suitable DC voltages to the ion trap 30.

The ions may be injected into the primary ion trap 60 via one or more lenses 50 such as a Z-lens 54, and a deflector electrode 58. As shown in FIG. 1, the one or more lenses 50 may include a so-called V-lens 52, followed by a Z-lens 54, followed by a high voltage (HV) focus lens 56.

The primary ion trap 60 is arranged downstream of the secondary ion trap 30 and is configured to receive and accumulate ions from the secondary ion trap 30 (via the one or more lenses 50 and the deflector electrode 58). In the embodiment depicted in FIG. 1, the primary ion trap 60 is a mass analyser ion trap, such as an electrostatic orbital trap, and more specifically an Orbitrap^{TM} FT mass analyser as made by Thermo Fisher Scientific.

As shown in FIG. 1, the orbital trap 60 comprises an inner electrode 61 elongated along the orbital trap axis and a split pair of outer electrodes 62, 63 which surround the inner electrode 61 and define therebetween a trapping volume in which ions are trapped and oscillate by orbiting around the inner electrode 61 to which is applied a trapping voltage whilst oscillating back and forth along the axis of the trap. The pair of outer electrodes 62, 63 function as detection electrodes to detect an image current induced by the oscillation of the ions in the trapping volume and thereby provide a detected signal (“transient”). .

The outer electrodes 62, 63 typically function as a differential pair of detection electrodes and are coupled to respective inputs of a differential amplifier (not shown in FIG. 1), which in turn forms part of a digital data acquisition system to receive the detected signal (transient). The detected signal (transient) can be processed using Fourier transformation to obtain a mass spectrum of ions within the trap.

FIG. 2 shows schematically the electrostatic trap mass analyser 60 in more detail, together with its detection circuitry. An image current is detected using a differential amplifier on the first outer electrode 62 and second outer electrode 63 of the trap. The first outer electrode 62 and second outer electrode 63 are referred to as detection electrodes. First conductor 64 and second conductor 65 carry a first image current signal and a second image current signal respectively to pre-amplifier 66. The pre-amplifier 66 comprises a first amplifier transistor T2, a second amplifier transistor T1, first resistor R1, second resistor R2, and an operational amplifier OP1. The first amplifier transistor T2 and the second amplifier transistor T1 are connected as a differential pair, together with first resistor R1 and second resistor R2 and a constant current source forming a differential amplifier.

Further details on the detection circuity shown in FIG. 2 are described in commonly assigned International Patent Publication No. WO 2012/152959.

Returning to FIG. 1, the mass spectrometer may optionally include a collision or reaction cell 40 downstream of the secondary ion trap 30. Where the collision or reaction cell 40 is present, ions collected in the secondary ion trap 30 can either be ejected orthogonally to the ion trap mass analyser 60 without entering the collision or reaction cell 40, or the ions can be transmitted axially to the collision or reaction cell 40 for processing before returning the processed ions to the ion trap 30 for subsequent orthogonal ejection to the mass analyser ion trap 60. The processing may comprise, for example, fragmenting the ions by collisions with a collision gas and/or a reagent in the collision cell 40, or further cooling the ions by collisions with a gas at a lower energy that does not fragment the ions.

As also shown in FIG. 1, the instrument is under the control of a control unit 70, such as an appropriately programmed computer, which controls the operation of various components of the spectrometer and, for example, sets the voltages to be applied to the various components of the spectrometer. The control unit 70 may also receive and process data from various components including the detector(s), e.g. perform Fourier transformation on detected signals.

The instrument may be operated such that successive batches of ions from the ion source 10 are each accumulated in and analysed by the ion trap mass analyser 60. Each batch of ions is firstly accumulated in the secondary ion trap 30, and then the accumulated ions (or e.g. fragment ions derived from the accumulated ions) are injected into the mass analyser 60. A respective detected signal (transient) is produced in respect of each batch of ions, and a respective mass spectrum may be produced from each detected signal (transient).

The mass spectrometer may be operable in various mode of operation. In particular, the mass spectrometer may be a tandem mass spectrometer operable in an MS1 mode of operation and an MS2 mode of operation.

In the MS1 (or “full mass scan”) mode of operation, a mass filter (not shown) of the ion transfer stages 20 is operated in a transmission mode of operation and the fragmentation device 40 is operated in a non-fragmentation mode of operation or is not utilised, e.g. so that a wide m/z range (e.g. full mass range) of unfragmented (“precursor” or “parent”) ions are analysed by the analyser 60 to produce an MS1 spectrum.

In the MS2 mode of operation, the mass filter is operated in a filtering mode of operation and the fragmentation device 40 is operated in its fragmentation mode of operation, e.g. so that a selected narrow m/z range of precursor ions are fragmented and the resulting fragment (“product” or “daughter”) ions are analysed by the analyser 60 to produce an MS2 spectrum.

The instrument may also be operable in one or more higher order fragmentation modes of operation, such as for example an MS3 mode of operation, whereby precursor ions are fragmented, at least some of the resulting fragment ions are themselves fragmented, and the second-generation fragment ions (“granddaughter ions”) are analysed by the analyser 60 produce an MS3 spectrum.

It is desirable that each batch of ions analysed by the mass analyser 60 includes as many ions as possible, so as to improve the statistics of the mass spectrum. However, undesirable space charge effects can occur at relatively high ion concentrations and can limit mass resolution and mass accuracy. Therefore, the total number of ions accumulated in the ion trap 30 is controlled to optimise the number of ions injected into the mass analyser 60 to be below, but as close as possible to, a limit for the mass analyser 60 such as the space-charge limit for the mass analyser 60. The total number of ions accumulated in the ion trap 30 may also or instead be controlled to be below a limit for the ion trap 30 such as the space-charge limit for the ion trap 30. Typically, between 1e4 and 1e6 elementary charges should be stored, such as between 1e5 and 5e5.

However, it may be the case that the flux of ions from the ion source 10 is highly variable. This is particularly the case where the ion source 10 is coupled to a separation device such as a liquid chromatography or capillary electrophoresis device, where the ion flux from the ion source 10 can vary over time by several order of magnitudes.

Therefore, embodiments use so-called automatic gain control (AGC) techniques to precisely control the total number of ions accumulated in the ion trap 30 despite a variable flux of ions into the trap 30. These techniques typically rely on an accurate and reliable real-time estimation of the present ion current J or ion flux being received by the ion trap 30. Then, by controlling the filling time Tf of the ion trap 30, the total number of ions or the total amount of charge accumulated in the trap 30 (and injected into the mass analyser 60) can be suitably controlled.

Thus, a batch of ions that is to be injected into the mass analyser 60 is first stored in the secondary ion trap 30, where its total charge Q = J*Tf can be determined by the secondary ion trap filling time Tf during which the secondary ion trap 30 receives an ion current J from the ion source 10. The accumulation time (e.g. fill time) of ions in the trap 30 is adjusted based on an estimation of the present ion current J or ion flux to control the total number of ions accumulated in the ion trap. In this way, the total number of ions N injected into the mass analyser 60 per scan can then be controlled in order to achieve an appropriate signal-to-noise ratio while avoiding adverse space-charge effects caused by the analyser overfilling.

The present ion flux can be estimated based on one or more measurements or estimations of an earlier ion flux into the trap 30. For example, the present ion flux can be estimated based on a measurement or estimation of the charge stored in the secondary ion trap 30 in one or several preceding scans, and then the secondary ion trap filling time Tf can be appropriately adjusted for subsequent scans.

An estimation of an earlier ion flux can be made based on the primary ion trap’s 60 mass analysis of a previous batch of ions. For example, once a batch of ions has been mass analysed by the mass analyser 60, all of the signal in the resulting mass spectrum above a noise threshold may be summed and converted to charge (or number of ions), e.g. using a conversion coefficient (which may, e.g., be determined during calibration). Determining the total charge of each successive batch of ions in this way provides a relatively frequent measure of the ion flux into the secondary ion trap 30 and can thereby allow the secondary ion trap filling time Tf time to be adjusted as needed relatively frequently.

In embodiments, the detection electrode(s) 62, 63 of the mass analyser 60 itself are used in a mode of operation to determine an ion current of or a total amount of charge of a group of ions (instead of providing a separate independent ion flux detector elsewhere in the instrument to do this). This is done by deliberately causing a group of ions collected in the secondary ion trap 30 to impact upon one or more of the detection electrode(s) 62, 63 of the mass analyser 60. The immediate impinging of the ions on one of the outer electrodes 62, 63 results in an electrical current which is converted to a voltage signal by the transimpedance amplifier. Moreover, the so-produced detected signal is indicative of the total amount of charge of the group of ions.

This can then be used to provide a fast and direct current measurement of the ion flux into the electrostatic ion trap 60. Such an ion current or charge measurement can in turn be used in an automatic gain control (AGC) procedure, for example to calibrate or adjust ion flux estimations based on the primary ion trap’s 60 mass analysis. Beneficially, by using the detection electrode(s) 62, 63 of the ion trap 60 itself to provide an ion current or charge measurement, there is no need to provide additional hardware elsewhere in the instrument for this purpose.

FIG. 1 illustrates the mass spectrometer being operated in a “normal” mass analysis mode of operation in which a mass spectrum of ions within the ion trap 60 is produced. Ions are ejected from the secondary ion trap 30 (C-Trap) towards the mass analyser 60 by applying ejection voltages to push and pull electrodes of the trap 30. When ions enter the mass analyser 60, the voltages applied to the central electrode 61 and to the deflector electrode 58 are dynamically changed from injection voltages to detection voltages. These voltages direct the ions into stable orbits lying in the space between the central electrode 61 and the outer electrodes 62, 63, where the ions orbit the central electrode 61 without touching any of the electrodes for an elongated time.

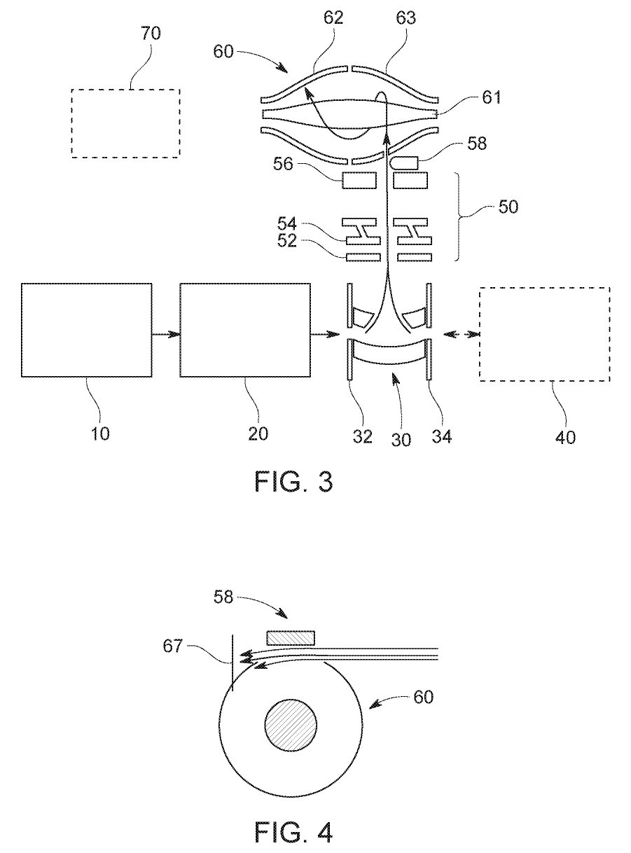

FIG. 3 shows the mass spectrometer of FIG. 1 being operated a second, charge resolving mode of operation. FIG. 3 is similar to FIG. 1, except the ion path within the ion trap 60 is shown as impacting upon one of the outer electrodes 62.

As shown in FIG. 3, the outer electrodes 62, 63 of the mass analyser 60 are used for fast direct current measurement when a group of ions is ejected from the secondary ion trap 30 and accelerated towards the mass analyser 60 and finally impinge on one of the two outer electrodes 62, 63 of the mass analyser 60 immediately after injection. In this way, the mass analyser 60 is itself used to provide a direct ion current readout. Thus, the existing mass analyser 60 and its detection electronics are used in a new method of fast ion flux measurement.

In embodiments, to cause the group of ions to impact upon one of the outer electrodes 62, 63, static voltages are applied to the central electrode 61 and to the deflector electrode 58 of the mass analyser assembly. When constant voltages are applied to the central electrode 61 and to the deflector electrode 58, the energy of the ions is too high, such that the ions cannot be trapped in the potential well of the electrostatic trap 60. (This is in contrast with the normal operation of the orbital ion trap 60, when the central electrode 61 voltage is gradually changed leading to a drop in ion energy upon injection.) In consequence, the ions will either hit the first outer electrode 63 immediately after injection into the mass analyser’s volume or impinge on the opposite second outer electrode 62 after the first flight around the central electrode 61, as shown in FIG. 3.

In the normal mass analysis mode of operation, the image current of oscillating ions is read out as a differential signal between the two outer electrodes 62, 63. Image current measurement of the oscillating ions are continued for an elongated time of up to few seconds. In the direct current detection mode of operation, the ion current is read out as an image current at the detection circuity as well. However, the direct current measurement of ions impinging on one of the outer electrodes will happen in a relative short time period, e.g. of less than 1 ms. At least two separate electronic channels, i.e. for each of the two different methods of image current readout, may be provided for further data processing.

In some embodiments, an additional electrode 67 can be placed behind the deflector electrode 58. In such a setup the ion bunch ejected from the C-Trap 30 should be focussed by the applied voltages to impinge on the additional electrode 67. The additional electrode 67 can either be electrical connected to the first outer electrode 63 or it can alternatively be connected to a separate charge detecting device.

FIG. 4 illustrates one such embodiment. As illustrated by FIG. 14, a screen electrode 67 is arranged adjacent to, e.g. slightly behind, the injection slot of the ion trap mass analyser 60. The screen electrode 67 is electrically connected (e.g. spot welded) to an outer electrode 63, 64 of the ion trap mass analyser 60. When it is desired to measure the ion current or charge of a packet of ions ejected from the C-Trap 30, the deflector 58 is operated with at a low voltage, e.g. so as to just deflect ions away from it, while the central electrode of the ion trap mass analyser 60 may be kept at a low voltage or at ground. The voltages are configured to minimise the share of the ions that are sent through the injection slot into the ion trap mass analyser 60, and to instead direct them to the screen electrode 67 behind the injection slot. This allows the ion current or charge of the packet of ions to be measured using the ion trap mass analyser’s electronics (as described above). In addition, and advantageously, most contamination is now deposited on the screen electrode 67 and not on the internal surface of the detection electrode(s) 63, 64 which should be kept clean for as long as possible.

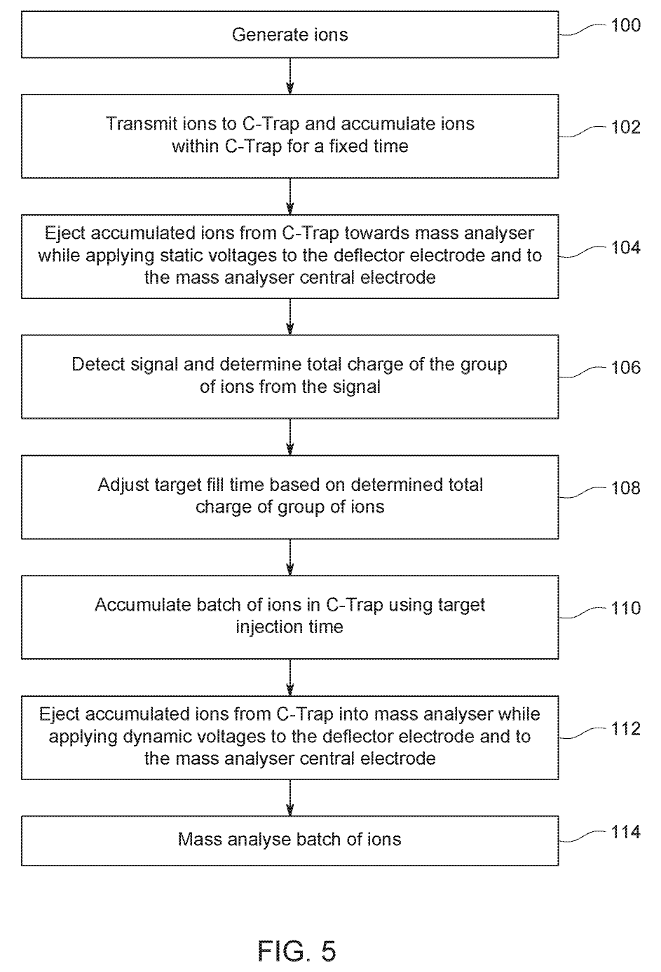

FIG. 5 illustrates a method in accordance with an embodiment, which may be carried out using the spectrometer shown in FIGS. 1-4.

As shown in FIG. 5, in a first step 100, ions are generated by the ion source 10. Ions generated by the ion source 10 are transmitted to the secondary ion trap 30 and accumulated therein for a set amount of time (step 102). The accumulated batch of ions is then ejected from the secondary ion trap 30 and transmitted towards the primary ion trap 60, while the instrument is operated in the charge detecting mode of operation, i.e. where static voltages are applied to the deflector electrode 58 and to the central electrode 61 (step 104). Under these voltage conditions, the batch of ions will impact upon one of the detection electrodes 62, 63. This produces a detected signal which is indicative of (e.g. proportional to) the total charge of the batch of ions, and so the total charge of the batch of ions can be determined from the detected signal (step 106).

The determined total charge is then used to adjust one or more subsequent target fill times for the secondary ion trap 30 in respect of one or more batches of ions that is to be mass analysed by the primary ion trap 60 (step 108). The adjusted target fill time is used when accumulating a subsequent batch of ions from the ion source 10 in the secondary ion trap 30, which is to be injected into the primary trap 60 for mass analysis (step 110). The accumulated batch of ions is then ejected from the secondary ion trap 30 and injected into the primary ion trap 60, while the instrument is operated in the mass analysis mode of operation, i.e. where dynamic voltages are applied to the deflector electrode 58 and to the central electrode 61 (step 112). Under these voltage conditions, the ions will take up stable orbits within the mass analyser 60 without touching any of the electrodes of the mass analyser 60 for an elongated time. The detected image current produced by the orbiting ions is Fourier transformed to produce a mass spectrum of the ions (step 114).

In the present embodiments, the determined total charge can be used to adjust subsequent target fill times in any suitable manner. For example, the total charge of each successive batch of ions may be determined from the mass analysis of each batch of ions by the mass analyser 60. For each batch of ions mass analysed by the mass analyser 60, all of the signal in the mass spectrum above a noise threshold may be summed and converted to charge (or number of ions), e.g. using a conversion coefficient (which may, e.g., be determined during calibration). The determined total ion charge may be used to calculate a target injection time for one or more subsequent batches of ions into the secondary ion trap 30 thereafter to be accumulated in the mass analyser 60.

In addition to this, charge detection measurements may be made intermittently between the mass analysis measurements. The measurement of ion current or charge may be carried out periodically and typically less frequently than mass analysis measurements. A charge detection measurement may be made, for example, once every few seconds (e.g., once every 5-10 s), between mass analysis measurements.

Then, the charge determined using the charge detection measurement may be compared to a corresponding charge determined using a mass analysis measurement. For example, a ratio of the charge determined using the charge detection measurement to the charge determined using the mass analysis measurement may be determined, and this ratio may be compared to an expected ratio. If the ratio different from the expected ratio, subsequent fill times into the secondary ion trap 30 can be adjusted accordingly to prevent overfilling or underfilling of the secondary ion trap 30 and/or primary ion trap 60.

Thus, the charge detection measurements can in effect be used to calibrate (e.g. scale) the charge estimations made using the mass analysis measurements.

In the normal mass analysis mode of operation, the m/z ratios of the ions are determined by observing their axial oscillation frequencies within the orbital ion trap 60. Ions generate an image current on the trap electrodes 62, 63 as they oscillate. The two outer-shell electrode sections 62, 63 are isolated from each other (typically by a quartz ring) and a differential amplifier 66 picks up the voltage difference between them. The whole ensemble of trapped ions generates a sum of induced-current signals distributed across a range of frequencies, which can be processed by Fourier transform or other processing methods to produce a mass spectrum.

Although differential signal detection reduces noise pickup by rejecting voltage fluctuations and any bias voltage common to both outer electrodes 62, 63, further signal processing is required to reach the necessary signal fidelity. Typically, spurious signals are generated by the voltage pulse applied to the orbital ion trap electrodes themselves and by the radiofrequency (RF) fields used to trap ions in the C-Trap 30 and other ion optics. Less predictable noise is generated by the operation of the turbopump and by the various types of power supplies found in a mass spectrometer. As most of these sources produce rather low frequency noise compared to the ion frequencies – axial oscillations on a typical Orbitrap^{TM} mass analyser lie roughly between 100kHz and 2MHz – a high-pass filter may be used inside the pre-amplifier to remove large portions of this noise. The frequency of the ion motion depends on the applied central electrode voltage as well as on the mass-to-charge ratio of the ions of interest.

Embodiments aim at improving the signal fidelity for an analyser operated both for image current and direct current ion detection. To facilitate direct current signal detection, the pre-amplifier’s gain curve was initially modified to increase amplification of low-frequency signals. This was initially done by not including a high-pass filter in the design. However, the resulting signal transients for image current detection contained significantly more noise. Even though this could be partially removed by digital signal processing, it reduced the dynamic range of the pre-amplifier.

Thus, embodiments provide a switchable pre-amplifier that offers two modes of operation: one for image current detection and one for direct current detection. While both modes share large parts of the electronic circuitry, the image current mode uses an additional high-pass filter before the signal amplification stage. The switching time is on the order of Orbitrap^{TM} mass analyser transient acquisition, ideally less than 32 ms.

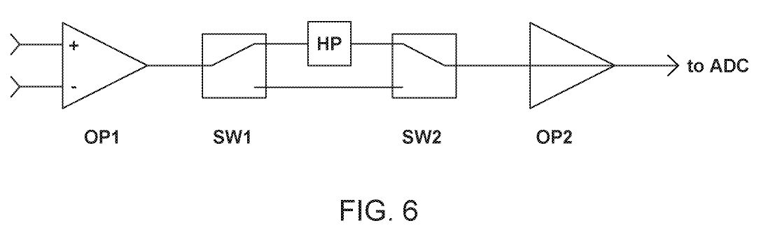

FIG. 6 shows a simplified block diagram of the switchable pre-amplifier. The pre-amplifier has a switchable signal path formed by a pair of switches SW1, SW2 arranged in series between first and second operation amplifiers OP1, OP2. OP1 serves as an input amplifier with high-impedance inputs and OP2 is a driver amplifier for transmitting the signals to further signal processing (ADC).

First and second signal paths are arranged between the pair of switches SW1, SW2. One of the signal paths includes a high pass filter HP, while the other does not. SW1 has a single input connected in series to the output of OP1, and a pair of outputs respectively connected to the first and second signal paths; and SW2 has a pair of inputs respectively connected to the first and second signal paths, and a single output connected in series to an input of OP2. In the mass analysis mode of operation, the pair of switches are controlled so that the received transient signal is high-pass filtered by HP; while in the ion current measurement mode of operation, the pair of switches are controlled so that received transient signals take the other signal path and are not high-pass filtered.

Passive components such as relays or active components such as transistors could be used for the switches SW1, SW2. However, passive MEMS switches are particularly beneficial, as they combine a long service life with very low signal distortion. Similarly the high-pass filter HP may be formed by passive components such as one or more capacitors and/or inductors.

As already mentioned above, FIG. 2 shows the input stage of the amplifier. The pre-amplifier 66 comprises a first amplifier transistor T2, a second amplifier transistor T1, first resistor R1, second resistor R2, and an operational amplifier OP1. The first amplifier transistor T2 and the second amplifier transistor T1 are connected to Orbitrap^{TM} mass analyser outer detection electrodes 62, 63 as a differential pair, together with first resistor R1 and second resistor R2 and a constant current source forming a differential amplifier. FIG. 6 then shows the same OP1 as shown in FIG. 2, together with the pair of switches SW1, SW2 and OP2.

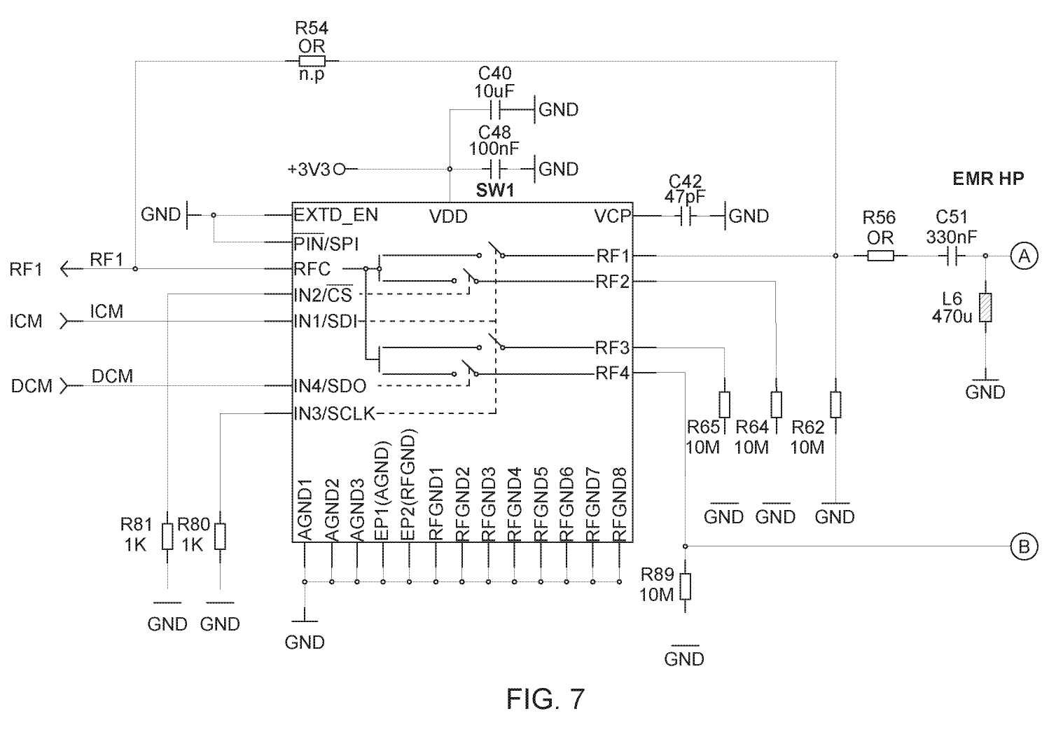

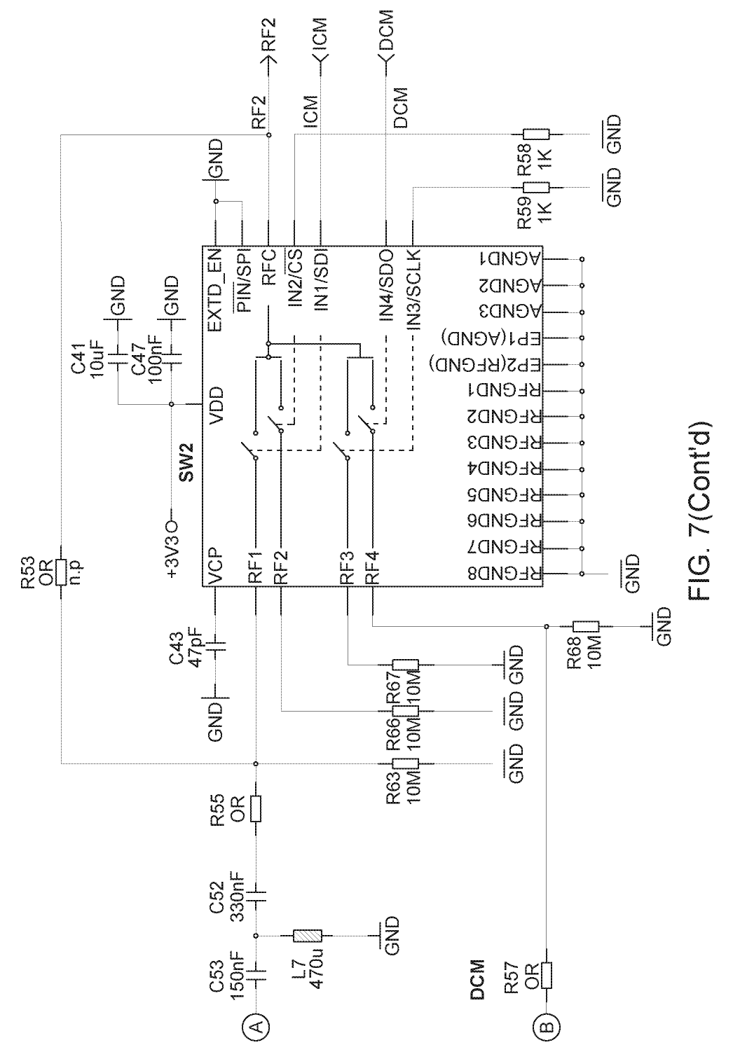

FIG. 7 shows detail of the switches SW1 and SW2, together with the high pass filter HP. As shown in FIG. 7, the high pass filter may be formed from three capacitors and two inductors; while a 0 Ohm resistor may provide the direct connection (“DCM”) between the two switches without a filter.

The filter itself may be built with passive components so as not to add any additional RF noise which might result in additional and unwanted signals inside the mass spectrum. For the same reason, the two switches may be passive (so without any active electrical components like transistors etc.) components. In this case, MEMS (Micro Electro-Mechanical Systems) switches may be used, which offer excellent reliability and RF performance. They offer high linearity and low insertion loss. High linearity means that no unwanted harmonic distortion is generated within the signal amplitude and frequency range, which for unsuitable components might also result in unwanted additional signal in the mass spectrum. Reliability is important the context of actuation lifetime, which is for the chosen part in the region of 1 billion cycles. In this application the instrument may be switched between the two modes up to once every 10 seconds, which results in an expected lifetime of more than 100 years.

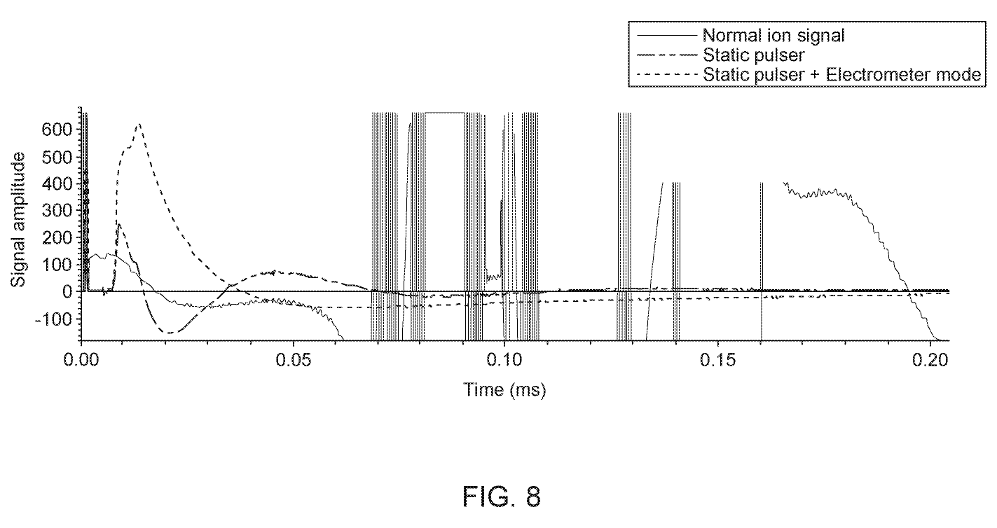

FIG. 8 shows a comparison of signals obtained using different modes of operation of the pre-amplifier. All three curves show the first 200 µs of a transient signal for ions of Flexmix^{TM} calibration standard acquired on a modified Orbitrap^{TM} Exploris^{TM} mass spectrometer.

As can be seen from FIG. 8, in the normal image current data acquisition mode, the pulsing of the Orbitrap^{TM} analyser electronics causes saturation of the pre-amplifier while the ions enter the Orbitrap^{TM} analyser during the first microsecond of the transient. This response is independent of the ion signal itself.

Fixing the voltages applied to the Orbitrap^{TM} analyser electrodes during the ion injection from the C-Trap causes them to impinge on the surface. The transient shows a small oscillating signal due to the distortion caused by the high-pass filter in the pre- amplifier. Switching the pre-amplifier to direct current mode eliminates this distortion and increases the response significantly.

Thus, switching the pre-amplifier mode alters the pre-amplifier’s gain curve so that low-frequency signals are suppressed during image current detection but are amplified during direct current detection. This allows measurement of the direct current signal generated by ions impinging on an electrode so that it can be used as an electrometer, while also providing the same high signal fidelity as conventional pre-amplifiers used for image-current detection.

It will be appreciated that the present switchable preamplifier provides a particular efficient design as the output signals from the pre-amplifier for both modes of operation can utilize substantially identical signal lines. This implementation allows the modified preamplifier to be retrofitted to existing instruments with minor changes to the electronics. In some embodiments, by repurposing one output from the instrument control electronics to send the switching command to the pre-amplifier, only minor software changes are required in addition to the hardware changes of the pre-amplifier. The modification of the pre-amplifier is simple (thus carrying little risk of an increase in error rate), compact (i.e. using the same footprint as the original pre-amplifier except for an additional wire for the switch command), and low-cost (as large parts of the pre-amplifier circuit are shared between both modes).

The switchable preamplifier allows fast execution of a pre-scan where the direct current mode is utilized for determining the ion flux. For ion current detection, the faster direct detection mode takes less than 1 millisecond of acquisition time compared to up to 20 milliseconds needed for a conventional pre-scan.

The same concept can be used to speed up calibration and signal optimization routines that only rely on overall signal intensity, i.e. that do not rely on individual m/z peak information but only on total ion current. The total ion current can be combined with the m/z information from a secondary analyser such as a quadrupole.

Although various particular embodiments have been described above, various alternative embodiments are possible.

For example, the type of ion trap is not limited to an electrostatic orbital trap as described above. Any type of ion trap that uses image current detection could be used, such as for example multi-reflection and multi-deflection electrostatic traps and time-of-flight analysers, orbital traps, including of Cassini type, with one or multiple inner electrodes, linear and 3D traps with RF trapping, and so on. Embodiments may be used in other image current detectors such as Fourier-transform ion cyclotron resonance (FTICR), RF-Ion Traps, and charge detection MS instruments.

Although the present disclosure has been described with reference to various embodiments, it will be understood that various changes may be made without departing from the scope as set out in the accompanying claims.

1. An analytical instrument comprising:
an ion detector configured to detect ions and to produce an ion signal characteristic of the detected ions; and
detection circuitry comprising a first input configured to receive an ion signal from the ion detector, a filter configured to filter a received ion signal, and a first output;
wherein the ion detector is configured to detect ions in a first mode of operation and to detect ions in a second mode of operation, wherein an ion signal produced by the ion detector in the first mode of operation is characteristic of a first property of the ions and an ion signal produced by the ion detector in the second mode of operation is characteristic of a second different property of the ions; and
wherein the detection circuitry is configured such that: (i) an ion signal produced by the ion detector in the first mode of operation is provided to the first output without being filtered by the filter; and such that (ii) an ion signal produced by the ion detector in the second mode of operation is filtered by the filter before being provided to the first output.

2. The instrument of claim 1, wherein the filter is a high-pass filter configured to filter a received ion signal to produce a high-pass filtered version of the received ion signal.

3. The instrument of claim 1, wherein the detection circuitry comprises:
a first switch configured to receive an ion signal from the first input;
a second switch configured to provide an ion signal to the first output;
a first signal path between the first and second switches, wherein the first signal path includes the filter; and
a second signal path between the first and second switches, wherein the second signal path bypasses the filter; and
wherein the detection circuitry is configured such that: (i) an ion signal produced by the ion detector in the first mode of operation is provided to the first output via the first signal path; and such that (ii) an ion signal produced by the ion detector in the second mode of operation is provided to the first output via the second signal path.

4. The instrument of claim 3, wherein:
the first switch has a single input connected to the first input, and a pair of outputs respectively connected to the first and second signal paths;
the second switch has a pair of inputs respectively connected to the first and second signal paths, and a single output connected to the first output; or
a combination thereof.

5. The instrument of claim 3, wherein the first switch, the second switch, or a combination thereof, is formed from one or more passive electronic component(s) such as a MEMS switch.

6. The instrument of claim 1, wherein the filter is formed from one or more passive electronic component(s).

7. The instrument of claim 1, wherein:
the first input comprises a first operation amplifier;
the first output comprises a second operational amplifier, or
a combination thereof.

8. The instrument of claim 1, wherein the detection circuitry further comprises processing circuitry configured to process an ion signal provided to the first output, wherein the processing circuitry is configured to determine a first property of ions detected in the first mode of operation and to determine a second different property of ions detected in the second mode of operation.

9. The instrument of claim 8, wherein the processing circuitry comprises a digitiser configured to digitise an ion signal received from the first output, and one or more digital signal processor(s) configured to process the digitised ion signal.

10. The instrument of claim 1, wherein:
the first property is a current or charge of the ions;
the second property is a mass to charge ratio (m/z) of the ions, or
a combination thereof.

11. The instrument of claim 1, wherein the ion detector comprises an ion trap, the ion trap comprises one or more detection electrodes, and one or more of the detection electrode(s) are configured to detect image current signals from ions trapped within the ion trap.

12. The instrument of claim 11, wherein the detection circuitry comprises a differential amplifier configured to receive an input ion signal from the image current detection electrodes and to provide an output ion signal to the first input.

13. The instrument of claim 11, wherein the instrument is configured such that:
in the first mode of operation, ions passed to the ion trap are caused to impact upon one or more of the detection electrode(s) of the ion trap so as to produce an ion signal;
in the second mode of operation, ions passed to the ion trap are trapped within the ion trap, and the one or more detection electrodes are used to detect image current signals from the ions trapped within the ion trap; or
a combination thereof.

14. The instrument of claim 13, wherein:
the instrument is configured such that, in the first mode of operation, ions are caused to impact upon one or more of the one or more detection electrode(s) that are configured to detect image current signals from ions trapped within the ion trap; or
the instrument is configured such that, in the first mode of operation, ions are caused to impact upon one or more of the one or more detection electrode(s) that are electrical connected to one or more of the detection electrode(s) that are configured to detect image current signals from ions trapped within the ion trap.

15. The instrument of claim 11, wherein the instrument comprises a control system configured to use a determined ion current or charge of a group of ions to control a number of ions in a batch of ions subsequently trapped in the ion trap.

16. The instrument of claim 11, wherein the ion trap is a primary ion trap, and the instrument is configured to accumulate a group of ions within a secondary ion trap and to pass the accumulated group of ions from the secondary ion trap to the primary ion trap.

17. The instrument of claim 16, wherein the control system is configured to control a number of ions in a batch of ions subsequently accumulated in the ion trap by controlling a fill time of ions into the secondary ion trap.

18. A method of operating an analytical instrument that comprises an ion detector and detection circuitry comprising a filter, the method comprising:
the ion detector detecting ions in a first mode of operation and producing a first ion signal characteristic of a first property of the detected ions, the detection circuitry receiving the ion signal from the ion detector, and the detection circuitry passing the received ion signal to an output without the ion signal being filtered by the filter; and
the ion detector detecting ions in a second mode of operation and producing a second ion signal characteristic of a second different property of the detected ions, the detection circuitry receiving the ion signal from the ion detector, the filter filtering the ion signal, and the detection circuitry providing the filtered version of the signal to the output.

19. The method of claim 18, wherein the ion detector comprises an ion trap and the first property is a current or charge of ions, and the method further comprises:
using a determined ion current or charge of a group of ions to control a number of ions in a batch of ions subsequently trapped in the ion trap.

20. A non-transitory computer readable storage medium storing computer software code which when executed on a processor performs the method of claim 18.
